(19) United States
(12) Patent Application Publication
(10) Pub. No.: US 2025/0324182 A1
(43) Pub. Date: Oct. 16, 2025

(54) DUAL CONE SPEAKER UNIT WITH INDEPENDENT ANALOG AND INTERNET PROTOCOL SPEAKERS

(71) Applicant: Valcom, Inc., Roanoke, VA (US)

(72) Inventors: Kevin LANE, Salem, VA (US); Gary RICE, Roanoke, VA (US); Tom HOOVER, Botetourt, VA (US)

(21) Appl. No.: 19/175,549

(22) Filed: Apr. 10, 2025

Related U.S. Application Data
(60) Provisional application No. 63/632,364, filed on Apr. 10, 2024.

(51) Int. Cl. H04R 1/02

(52) U.S. Cl. CPC H04R 1/025

(57) ABSTRACT

A dual cone speaker unit with an analog speaker and a separate internet protocol speaker in a single housing. The analog speaker may generally be configured to be UL-1480 Code compliant and may be configured to be used in a public notification system that is designed for evacuation, fire notification, and other emergency communications. The disclosed dual cone speaker system improves existing analog speaker systems and internet protocol speaker systems by eliminating the need for a separate housing for the two speakers, which reduces installation time and labor by reducing the mounting hardware, wiring, and holes to be made in the walls of the facility.

### CROSS-REFERENCE TO RELATED APPLICATION(S)

This application claims the benefit of U.S. Provisional Patent Application No. 63/632,364, filed on Apr. 10, 2024, the entire disclosure of which is herein incorporated by reference.

### BACKGROUND OF THE INVENTION

### Field of Invention

This disclosure is related to the field of speakers, and more particularly to a dual input speaker where one half is analog UL-1480 compliant and the other half is Voice over Internet Protocol compatible.

### Description of the Related Art

Communication is an essential part of an effective organization. Organizations needing to communicate with a large number of people often use speaker and paging systems to relay or transmit the information to everyone in the organization at one time. For example, hospitals, airports, police stations, public shopping outlets, public schools, power plants, manufacturing facilities, office buildings, medical buildings, sports and entertainment arenas, laboratories and research facilities, and others use speaker and paging systems to communicate important information to those within earshot. Historically, the speaker and paging system typically utilized in these applications for communications was a Public Address (“PA”) system. A PA system is essentially a collection of microphones, amplifiers, and speakers that facilitate one-way communication from the location of the microphone to the location, or multiple locations, of the speaker or speakers.

In these traditional PA systems, the communication begins at a microphone and ends at one or more speakers connected to the system, and typically, installation of these systems is a cumbersome process that requires a specialized technician. For example, traditionally, PA systems have a wire connecting a device with a microphone (like a telephone) to an amplifier or a series of amplifiers, which provide power to connected speakers. Wiring is then connected from the amplifier to a volume control device, then to the first speaker, and then from the first speaker to each subsequent speaker in the system. In applications where the PA system is used for paging and communications, the device with a microphone is most typically a telephone that is hardwired into the system. In these applications, the communication is made by dialing a predetermined code on the telephone, the communication being spoken into the telephone, then the amplifier broadcasts the message to the connected speakers.

These PA systems typically either transmit the communication to every speaker in the system, which is not ideal in some situations where the message only needs to be sent to specific areas, or allow the selection of a specific zone of speakers to have the communication broadcasted, which requires a separate wiring configuration for the speakers in each of the different zones. This system requires a technician to run wiring to and from each component in the system, which is time consuming and tedious, especially when wiring the system to have separate zones. Additionally, these traditional PA systems require either analog components or installation of an adapter to provide an interface between the analog and digital components, and expensive copper wiring, rather than more modern and inexpensive CAT5, CAT6, or other ethernet wiring. As such, many facilities have upgraded to some sort of Voice over Internet Protocol (VoIP) speakers system to replace the antiquated traditional PA system.

A VoIP speaker system provide many advantages to the traditional PA system. Notably, they typically allow communications to be sent to specific speakers without the need for specifically wired zones and typically do not require a specialized technician to install. For example, VoIP speaker systems use a phone system connected to an internet protocol (IP) gateway, which is connected to a network and various IP speakers can be connected to the network via ethernet cables. The system works by dialing a predetermined code on the phone, making the communication, then the communication is transmitted through the network to the connected speakers.

This is similar to how the traditional PA system works, with one large difference: the speakers that will output the communication are much easier to select individually and the volume of the speakers can be increased or decreased on the phone, instead of at the speaker or amplifier. Because these systems run off of ethernet connection, which is vastly simpler to install than running copper wiring, these systems typically do not require a specialized technician running various cables like what is necessary for traditional PA systems. While these VoIP speaker systems are cheaper and easier to install than traditional analog PA systems, the VoIP speaker systems require IP speakers, which may make the VoIP speaker systems less desirable in applications with existing analog speakers.

However, as mentioned above regarding traditional PA systems, an adapter can be installed in a traditional PA system to convert it to VoIP. This is essentially creating a hybrid analog-VoIP system. The adapter can be another gateway that is connected in the PA system before the amplifier, or some other power over ethernet switch that is connected before the amplifier. The adapter essentially connects the amplifier to the network, which allows the phone system connected to the other end of the network to be heard at the speakers connected to the amplifier. This is an alternative option to converting a whole analog PA system into a VoIP and allows retrofitting existing analog speakers to be used in the VoIP system rather than installing special IP speakers. Thus, the hybrid analog-VoIP system has the benefits of the VoIP speaker system without the burden of requiring installation of new IP speakers.

In addition to the paging and communications functions of a speaker system, many of the organizations and facilities that use speaker and paging systems, often also require a speaker system to be utilized for fire alarms and signaling. For example, hospitals, airports, police stations, public shopping outlets, public schools, power plants, manufacturing facilities, office buildings, medical buildings, sports and entertainment arenas, and laboratories and research facilities, and other facilities, typically are required by regulation to have a fire alarm system, compliant with the various National Fire Protection Association (NFPA) Codes. Historically, in order to comply with the requisite Codes, the speakers for fire alarms and fire systems needed to be a completely separate system from any speakers using a VoIP speaker system.

Specifically, all speakers and amplifiers that are used as a speaker in a public notification system that is designed for evacuation or fire notification are required to comply with the UL-1480 Code, which incorporates NFPA 70, the National Electric Code (NEC), and NFPA 72, the National Fire Alarm and Signaling Code. Compliance with UL-1480 typically requires meeting certain safety specifications for electrical performance, environmental testing, flammability, mechanical durability, ratings for various levels of moisture, and other factors. Likewise, NFPA 70 and NFPA 72 both require meeting various safety specifications for fire signaling and emergency communications, as well as requiring certain specifications for mass notifications for various events. Compliance with these Codes has typically been met by use of UL-1480 certified speakers and components, which are generally analog speakers.

In many cases IP speakers cannot meet the requisite NFPA and UL standards and code to be used in fire alarm systems because the speakers typically used for this Code compliance are analog. Resultingly, to be compliant with these Codes, many organizations install two completely separate speaker systems, with separate housing, mounting hardware, and wiring, to provide a more generally useful VoIP system and the required analog system.

These two separate speaker systems are cumbersome for a number of reasons. Each separate speaker system requires its own wiring, which requires installing two sets of wiring and may require creating additional holes in the walls to allow the newly installed wiring to connect to each separate speaker system. Also, the separate speaker systems each require their own mounting hardware, which increases the cost of installation, and have to be installed separately, which increases the duration of installation and cost of labor. Additionally, because each system is installed separately, more space is required for separate analog speakers and VoIP speakers. Further, separate speaker systems require separate preventative or routine maintenance to be performed, which is an additional cost due to the additional labor and time to perform the routine maintenance on two systems, rather than just one.

Because of these and other problems in the art, described herein, among other things, is a single duel cone speaker unit comprising two separate speakers, wherein the two separate speakers include an analog UL-1480 Code compliant speaker and an IP speaker in a single housing. This single dual cone speaker system eliminates the need for a separate housing for the two speaker systems, which eliminates the need for additional mounting hardware, additional wiring, and additional holes to be made in the walls of the facility. Additionally, this single dual cone speaker system reduces the space the speakers take up in the facility because both speakers are in a single speaker housing, and reduces the time and labor to install both an analog speaker system and a VoIP speaker system by only requiring one installation for the two speakers.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some aspects of the invention in a simplified form as a prelude to the more detail description that is presented later.

There is described herein, in an embodiment, a dual cone speaker unit with an analog speaker and a separate internet protocol speaker in a single housing. The analog speaker may generally be configured to be UL-1480 Code compliant and may be configured to be used in a public notification system that is designed for evacuation, fire notification, and other emergency communications. The disclosed dual cone speaker system may improve existing analog speaker systems and internet protocol speaker systems by eliminating the need for a separate housing for the two speakers, which may reduce installation time and labor by reducing the mounting hardware, wiring, and holes to be made in the walls of the facility.

In an embodiment, there is a dual cone speaker unit comprising: a housing comprising a faceplate and a backbox; said backbox further comprising a front side and a rear side, said front side of said backbox comprising at least two recesses, each of said at least two recesses including a raised portion positioned along one side of each of said at least two recesses; an analog speaker, said analog speaker electrically connected to a transformer; said transformer further comprising transformer connections, including an adjustment dial; said analog speaker positioned in a first recess of said at least two recesses; said transformer positioned on said front side of said backbox on said raised portion of said first recess; and said transformer connections, including said adjustment dial, positioned on said rear side of said backbox at a position corresponding to said position of said transformer on said raised portion of said first recess; an internet protocol speaker, said internet protocol speaker electrically connected to a printed circuit board; said internet protocol speaker positioned in a second recess of said at least two recesses and said printed circuit board positioned in a printed circuit board enclosure; said printed circuit board enclosure positioned on said rear side of said backbox in a position corresponding to said raised portion of said second recess; said printed circuit board further comprising a connection port for electrically connecting an ethernet cable; wherein installation of said housing installs said analog speaker and said internet protocol speaker simultaneously; and wherein, after said installation of said housing, said analog speaker transformer connections are electrically connected to electrical wiring and said internet protocol speaker printed circuit board is electrically connected to said ethernet cable.

In an embodiment, the analog speaker of the dual cone speaker unit is compliant with NFPA UL-1480 Code.

In other embodiments, the housing of the dual cone speaker unit is configured to be installed in place of an existing ceiling tile.

In other embodiments, the housing of the dual cone speaker unit is configured to be installed in a wall with said faceplate being flush with the surface of said wall.

In other embodiments, the housing of the dual cone speaker unit includes a mounting box, said mounting box configured to mount said housing on the surface of a ceiling or a wall.

In an embodiment, the faceplate of the dual cone speaker unit includes a fine-perforated grille covering.

In an embodiment, the transformer of the dual cone speaker unit is wired with primary taps at 0.25 W, 0.5 W, 1.25 W, 2 W, 2.5 W, 5 W, or any combination thereof.

In an embodiment of the dual cone speaker unit, adjusting the adjustment dial changes the output volume of said analog speaker.

In an embodiment, the installation of the dual cone speaker unit housing is performed to retrofit an existing speaker system.

### BRIEF DESCRIPTION OF THE DRAWINGS

FIG. 1 depicts an exploded view of an embodiment of a dual cone speaker unit.

FIG. 2 depicts the dual cone speaker unit of FIG. 1 with the faceplate removed, illustrating a top down view of the internals of the backbox, the analog speaker, and the internet protocol speaker.

FIG. 3 depicts a view of the back of dual cone speaker of FIG. 1, illustrating the exterior of the backbox

### DESCRIPTION OF THE PREFERRED EMBODIMENT(S)

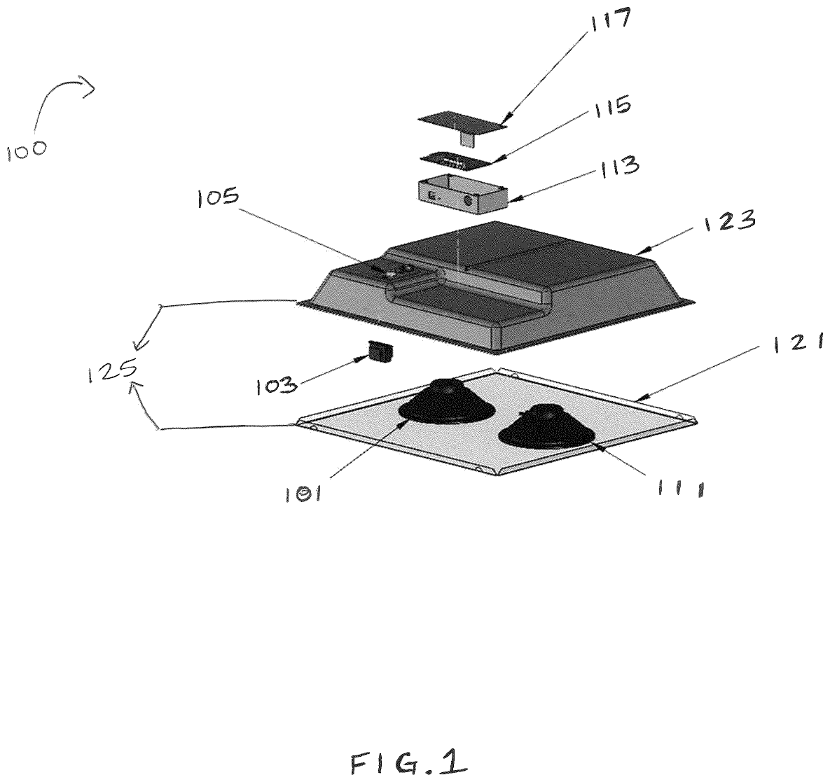

FIGS. 1-3 depict an embodiment of a dual cone speaker unit (100) with two separate speakers, of which one is typically analog (101) and one is typically internet protocol (“IP”) (111). The analog speaker (101) may generally be configured to be meet the electrical performance, environmental testing, flammability, mechanical durability, moisture level ratings, and other factors necessary to be compliant with the NFPA UL-1480 Code. The UL-1480 Code complaint analog speaker (101) may further be configured to be used in a public notification system that is designed for evacuation, fire notification, and other emergency communications. The IP speaker (111), on the other hand, may be configured as a VoIP system that may be connected to the network via ethernet cables or wiring, which may allow for communications from a phone system connected to the other end of the network to be sent to the IP speakers (111) via the ethernet cables or wiring so that the communication is heard at the IP speakers (111). In other embodiments, the IP speaker (111) may be a hybrid analog-VoIP system that includes an adapter that may be used to convert a traditional PA system into a VoIP system by connecting the amplifier to the network, which may allow for communications from a phone system connected to the other end of the network to be heard at the IP speakers (111) connected to the amplifier.

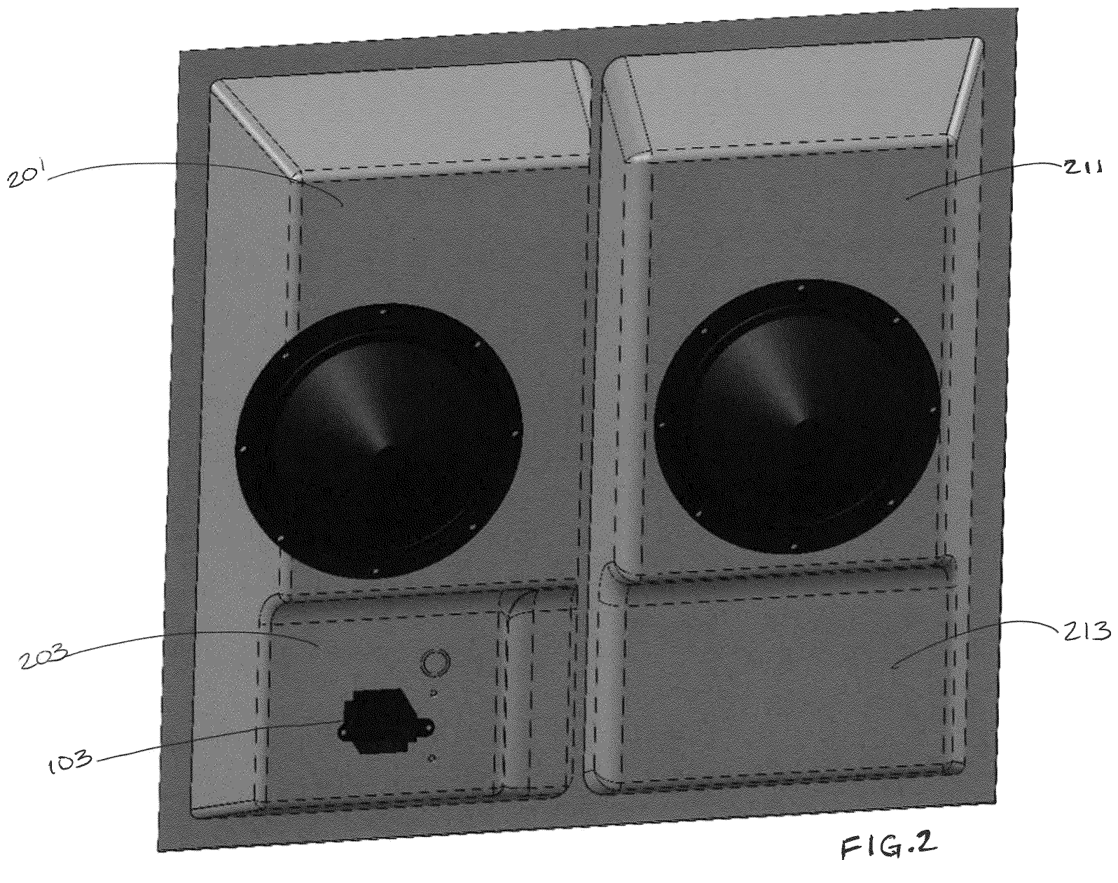

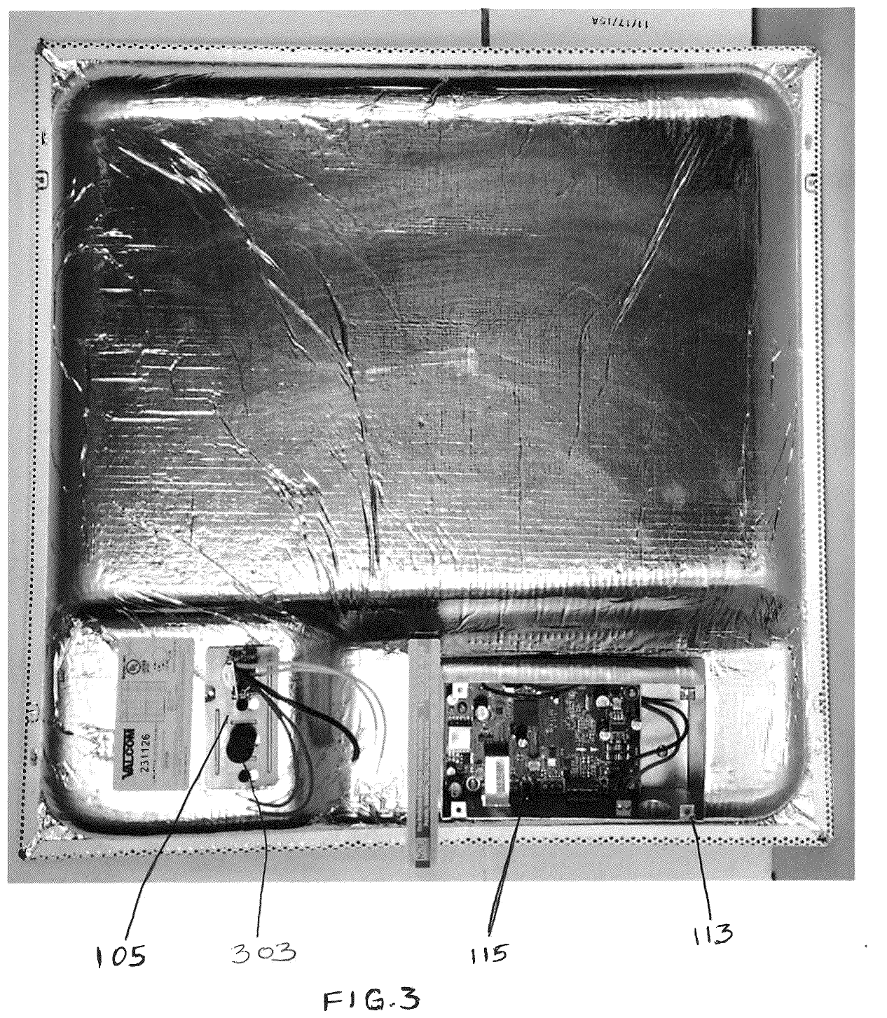

FIG. 1 depicts an exploded view of an embodiment of the dual cone speaker unit (100) in a single housing (125), showing a faceplate (121) and a backbox (123), the analog speaker (101), associated transformer (103), and transformer connections (105), and the IP speaker (111), a IP speaker printed circuit board (“PCB”) (115), a PCB enclosure (113), and a PCB enclosure cover (117). FIG. 2 depicts a front view of an embodiment of the dual cone speaker unit (100) with the faceplate (121) removed to show a transformer (103), recesses (201) and (211), steps (203) and (213), and a top view of the analog speaker (101) and IP speaker (111). FIG. 3 depicts the rear side of the backbox (123) to show the analog speaker transformer connections (105) and the IP speaker PCB (115) positioned in the IP PCB enclosure (113).

The housing (125) of the depicted dual cone speaker unit (100) is generally formed by connecting the faceplate (121) to the backbox (123), which is typically done at the manufacturer, and is generally in the configuration of a rectangular prism. However, this rectangular prism configuration is by no means required and in other embodiments the housing (125) is in the configuration of a generally circular prism. In further embodiments, the housing (125) is in the configuration of a generally oval prism. In yet other embodiments, the housing (125) may be in the configuration of other geometrically shaped prisms, such as a hexagonal prism, a triangular prism, an octagonal prism, among others. The housing (125) is designed to generally house both the analog speaker (101), the IP speaker (111), and the various electronic components associated with each speaker, described in further detail herein.

As depicted in FIGS. 1 and 2, the faceplate (121) is generally in the configuration of a rectangular prism that is sized and shaped to attach to the backbox (123). However, like the housing (125), this is by no means required, and the faceplate (121) may be in any of the above described housing (125) configurations. The faceplate (121) in the depicted embodiment is a fine-perforated grille covering that fits over the backbox (123), which could provide the appearance of a ceiling tile for aesthetic purposes. In other embodiments, the faceplate (121) is a vinyl or cloth grille covering. In further embodiments, the faceplate (121) may include apertures, screw holes, or other openings, sized and shaped to receive a fastener, which may be installed to mount the dual cone speaker unit (100) in the desired location.

In some embodiments, the depicted dual cone speaker unit (100) may be installed within a ceiling as a “lay-in” speaker that is flush with the ceiling. For example, the speaker unit (100) may be installed in place of an existing ceiling tile. This placement, however, is not required and in alternative embodiments, the dual cone speaker unit (100) may be installed within a wall such that the faceplate (121) is flush with the wall surface, as a free-standing speaker unit, or may have an exterior mounting box that may be mounted on the surface of a wall or ceiling, rather than being installed flush with the wall or ceiling. Further, the dual cone speaker unit (100) according to this disclosure may be installed in facilities with either existing copper wiring for an analog system or existing power over ethernet cabling for an IP system, as well facilities seeking to retrofit or upgrade their existing system.

The backbox (123) is sized and shaped to connect to the faceplate (121), provides housing for the analog speaker (101), the IP speaker (111), and the electronic components for each speaker, described elsewhere herein. The backbox (123) is designed primarily to support the transformer (103), transformer connections (105), the analog speaker (101), the PCB enclosure (113), the PCB (115), and the IP speaker (111). The backbox (123) also generally serves to focus the sound waves from the speakers (101) and (111) to boost the sound quality, act as an acoustic dampener, and prevent sound from escaping through the ceiling space above.

In the depicted embodiment, the backbox (123) has recesses (201) and (211) that are generally rectangular shaped and contain a raised portion, or step (203) and (213), on one side. A first raised portion (203) is sized and shaped to provide space for the transformer connection (105) for the analog speaker (101). A second raised portion (213) is sized and shaped to provide space for the PCB (115) and associated PCB enclosure (113) for the IP speaker (111). As shown in FIG. 2, the analog speaker (101) is positioned in the first recess (201) of the backbox (123) and the IP speaker (111) is positioned in a second recess (211) of the backbox (123).

The transformer (103) for the analog speaker (101) is generally a 25V/70V, dual voltage transformer, which is typically wired at the manufacturer, and with primary taps at various wattages of 0.25 W, 0.5 W, 1.25 W, 2 W, 2.5 W, 5 W, or any combination thereof. The transformer (103) is positioned on the step (203) in the first recess (201), as depicted in FIG. 2, and is positioned to interfaces with the transformer connection (105).

The transformer connections (105) are positioned on the rear of the backbox (123) and interface with the transformer (103), as depicted in FIGS. 1 and 3. Wiring from the transformer (103) protrudes out of the transformer connections (105), as depicted in FIG. 3, to permit an external electrical connection to be formed when the dual cone speaker unit (100) is installed, as described further herein. Additionally, the transformer connections (105) include an adjustment dial or knob (303), which may be used to adjust the output of the analog speaker (101).

The PCB enclosure (113) for the IP speaker (111) is attached to the rear of the backbox (123) in a position corresponding to the step (213) in the second recess (211), as depicted in FIG. 1. As further depicted in FIG. 1, the PCB (115) for the IP speaker (111) is positioned inside the PCB enclosure (113). In the depicted embodiment, the PCB enclosure includes a PCB cover (117), which is sized and shaped to fit as a lid on the PCB enclosure (113). However, this PCB cover (117) is not required and in other embodiments the cover (117) is omitted. Additionally, the PCB (115) includes a connection port for which an ethernet cable, CAT 5 cable, CAT 6 cable, or similar cable can be electrically connected.

The configuration of the depicted dual cone speaker unit (100) allows installation of both the analog speaker (101) and the IP speaker (111) to be accomplished essentially simultaneously. Specifically, because the analog speaker (101) and IP speaker (111) are in a single housing, the physical installation of both speakers (101) and (111) is completed in one step of mounting the dual cone speaker unit (100) in the desired location. Additionally, because the wiring that electrically connects the analog speaker (101) to the transformer (103) and transformer connections (105) and the wiring that electrically connects the IP speaker (111) to the PCB (115) is typically completed at the manufacturer, the electrical installation requires only connecting an external electrical connection to the wiring protruding from the transformer connections (105) and connecting an ethernet cable, CAT 5 cable, CAT 6 cable, or similar power over ethernet cable to the PCB (115). Thus, the dual cone speaker unit (100) allows for simpler installation of two different speakers than currently available because both speakers are in a single unit and can be installed with reduced steps. Additionally, the dual cone speaker unit (100) may be used in retrofitting existing speaker systems in facilities without requiring a completely separate speaker system to be installed.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “perpendicular” are purely geometric constructs and no real-world component or relationship is truly “perpendicular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout.

1. A dual cone speaker unit comprising:
a housing comprising a faceplate and a backbox;
said backbox further comprising a front side and a rear side, said front side of said backbox comprising at least two recesses, each of said at least two recesses including a raised portion positioned along one side of each of said at least two recesses;
an analog speaker, said analog speaker electrically connected to a transformer;
said transformer further comprising transformer connections, including an adjustment dial;
said analog speaker positioned in a first recess of said at least two recesses;
said transformer positioned on said front side of said backbox on said raised portion of said first recess; and
said transformer connections, including said adjustment dial, positioned on said rear side of said backbox at a position corresponding to said position of said transformer on said raised portion of said first recess;
an internet protocol speaker, said internet protocol speaker electrically connected to a printed circuit board;
said internet protocol speaker positioned in a second recess of said at least two recesses and said printed circuit board positioned in a printed circuit board enclosure;
said printed circuit board enclosure positioned on said rear side of said backbox in a position corresponding to said raised portion of said second recess;
said printed circuit board further comprising a connection port for electrically connecting an ethernet cable;
wherein installation of said housing installs said analog speaker and said internet protocol speaker simultaneously; and
wherein, after said installation of said housing, said analog speaker transformer connections are electrically connected to electrical wiring and said internet protocol speaker printed circuit board is electrically connected to said ethernet cable.

2. The dual cone speaker unit of claim 1, wherein said analog speaker is compliant with NFPA UL-1480 Code.

3. The dual cone speaker unit of claim 1, wherein said housing is configured to be installed in place of an existing ceiling tile.

4. The dual cone speaker unit of claim 1, wherein said housing is configured to be installed in a wall with said faceplate being flush with the surface of said wall.

5. The dual cone speaker unit of claim 1, wherein said housing further comprises a mounting box, said mounting box configured to mount said housing on the surface of a ceiling or a wall.

6. The dual cone speaker unit of claim 1, further comprising said faceplate including a fine-perforated grille covering.

7. The dual cone speaker unit of claim 1, wherein said transformer is wired with primary taps at 0.25 W, 0.5 W, 1.25 W, 2 W, 2.5 W, 5 W, or any combination thereof.

8. The dual cone speaker unit of claim 1, wherein adjusting said adjustment dial changes the output volume of said analog speaker.

9. The dual cone speaker unit of claim 1, wherein said installation of said housing is performed to retrofit an existing speaker system.
